(19) United States
(12) Patent Application Publication
(10) Pub. No.: US 2006/0123974 A1
(43) Pub. Date: Jun. 15, 2006

(54) Mouthpiece extractor

(76) Inventor: William N. Cave, Qualicum Beach (CA)

Correspondence Address: THERESA M. KOSTER, 1890 FERNOALE RD., VICTORIA, BC, V8N 2Y3, CA

(21) Appl. No.: 11/010,923

(22) Filed: Dec. 14, 2004

(51) Int. Cl. G10D 9/00

(52) U.S. Cl. 84/453

(57) ABSTRACT

A mouthpiece extractor for use with a mouthpiece that has become stuck in the lead pipe of a musical instrument. The mouthpiece extractor has a shaft with a shaft shoulder at one end and a plug at the other end. A moveable weight slides over the shaft, but is prevented from sliding past the shoulder or plug. A housing is coupled with the plug and is operative to hold the mouthpiece. When a mouthpiece is stuck in a lead pipe, the mouthpiece is placed in the housing, and the moveable weight is slid from the plug to the shaft shoulder. When the moveable weight contacts the shaft shoulder, a shock is generated which knocks the mouthpiece from the lead pipe.

### FIELD OF THE INVENTION

This invention relates to a mouthpiece extractor and in particular to a device for extracting a mouthpiece from a musical instrument.

### BACKGROUND

Devices for removing a stuck mouthpiece from the lead pipe of a musical instrument are known in the art, such as the one described in U.S. Pat. No. 3,971,288. Such devices typically work by applying pressure, for example by leveraging between the mouthpiece and the lead pipe. However, as the mouthpiece can often be firmly stuck in the lead pipe, considerable force may be required to remove the mouthpiece, causing damage to the lead pipe. In some cases a second tool such as a hammer may be required to strike the device to aid in removing the stuck mouthpiece. Furthermore, known devices may be cumbersome and time consuming to use, requiring two people, one to hold the musical instrument and another to attach the device. Accordingly there is a need for device for removing a mouthpiece that has become stuck in the lead pipe of a musical instrument that does not cause damage to the lead pipe and is simple and quick to use.

### BRIEF DESCRIPTION OF THE DRAWINGS

FIG. 1 illustrates a simplified exploded longitudinal view of one embodiment of the present invention;

FIG. 2 illustrates a simplified unexploded longitudinal cross-sectional view of the embodiment of FIG. 1;

FIG. 3 illustrates a simplified unexploded longitudinal cross-sectional view of the embodiment of FIG. 1;

FIG. 4 illustrates a flowchart depicting how the present invention functions;

FIG. 5 illustrates a simplified end view of a housing portion of the present invention;

FIG. 6 illustrates a simplified side view of an alternate embodiment for a housing;

FIG. 7 illustrates a simplified cross-sectional view taken along line C-C of FIG. 6;

FIG. 8 illustrates a simplified partially exploded longitudinal cross-sectional view of an alternate embodiment of the present invention;

FIG. 9 illustrates a simplified unexploded longitudinal cross-sectional view of the embodiment of FIG. 8;

FIG. 10 illustrates a simplified side elevation of an attachment for use with the present invention;

FIG. 11 illustrates a simplified bottom view of the attachment of FIG. 10; and

FIG. 12 illustrates a perspective view of an embodiment of the present invention.

### DETAILED DESCRIPTION OF THE DRAWINGS AND PRESENTLY PREFERRED EMBODIMENTS

Herein, the phrase “coupled with” is defined to mean directly connected or indirectly connected through one or more intermediate components.

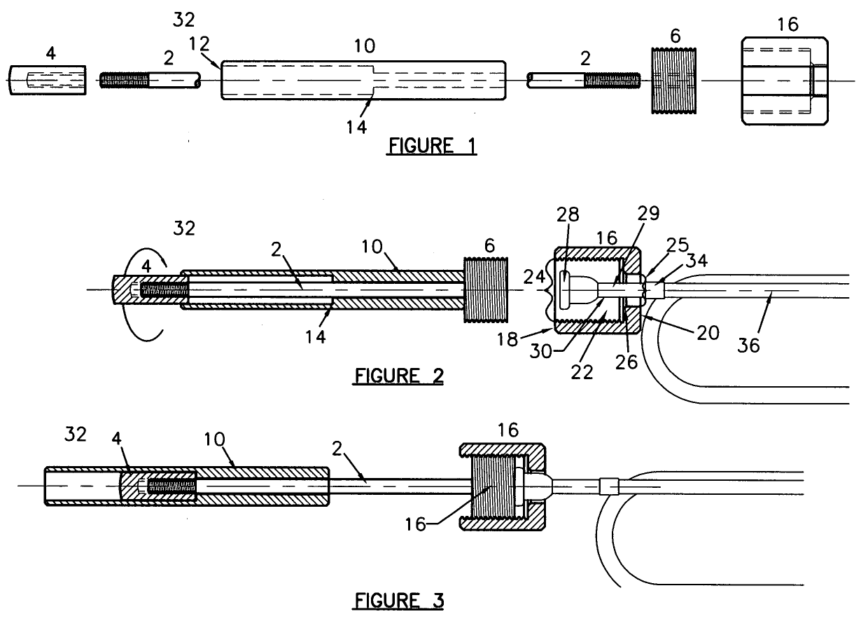

Referring now to FIG. 1, there is illustrated a mouthpiece extractor 32 in accordance with an embodiment of the present invention. A shaft 2 is coupled at one end with a shaft shoulder (or contact surface) 4 and at the other end with a plug 6. An optional nut (not shown) may be employed to maintain a tight coupling between the shaft 2, shaft shoulder 4, and plug 6. Although the means of coupling the shaft 2, shaft shoulder 4, and plug 6 is depicted as a threaded coupling, it will be appreciated that other means of coupling may be employed without departing from the spirit of the present invention.

A moveable weight 10 having an end 12 is coupled with the shaft 2, shaft shoulder 4, and plug 6 such that the moveable weight 10 can slide freely over the shaft, but is prevented from sliding past the shaft shoulder 4 or the plug 6. In one embodiment the moveable weight 10 has an internal shoulder 14. The end 12 is sized to slide freely over the shaft shoulder 4, but the internal shoulder 14 is sized to prevent the internal shoulder from progressing past the shaft shoulder 4. In an alternate embodiment (not shown), the end 12 of the moveable weight 10 is sized to prevent the end 12 from progressing past the shaft shoulder 4.

A housing 16 is coupled with the plug 6.

Referring now to FIG. 2, the housing 16 has a plug end 18, an instrument end 20, and an annular hollow center 22 therethrough, the center 22 having a wider diameter opening 24 at the plug end 18 and a narrower diameter opening 25 at the instrument end 20, the center 22 having a shoulder 26. The wider diameter opening 24 is wide enough to accommodate a rim 28 of a mouthpiece 30, the narrower diameter opening 25 is wide enough to accommodate a shank 29 of mouthpiece 30 and a lead pipe 34 of an instrument 36, and the shoulder 26 is sized to prevent the rim 28 from sliding past the shoulder 26.

In the present embodiment, the housing 16 is coupled with the plug 6 by being threaded together. However, other means of coupling the housing 16 and the plug 6 may be employed without departing from the spirit of the invention.

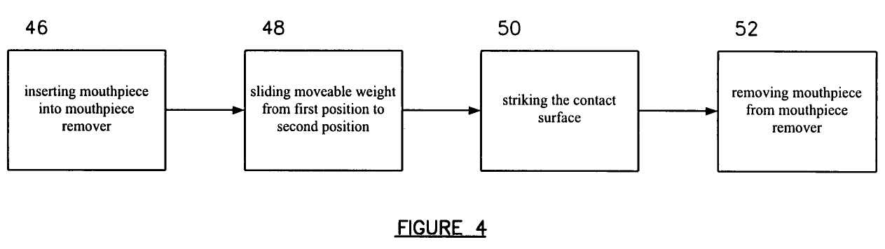

In operation, when shank 29 is firmly stuck in lead pipe 34 of instrument 36, the mouthpiece 30 is inserted into the housing 16 (as depicted in FIG. 2), the housing 16 is coupled with the plug 6, such that the mouthpiece 30 is held in place between the housing 16 and plug 6 (as depicted in FIG. 3). The moveable weight 10 is placed in a position near to the plug 6 (as depicted in FIG. 2). The moveable weight 10 is made to slide towards the shaft shoulder (as depicted in FIG. 3), and when the end 12 of the moveable weight 10 or the internal shoulder 14 contacts the shaft shoulder 4, a shock is generated which causes the shank 29 to be knocked out of the lead pipe 34. When the shank 29 is very firmly stuck in the lead pipe 34, it may take a few operations of this procedure to knock the shank 29 from the lead pipe 34.

The mouthpiece extractor 32 will fit instruments including the French Horn, Cornet, Trumpet, Fugal Horn, Bb Tenor Horn, Euphonium, Tenor Trombone, Bass Trombone and any other pitch instruments with mouthpieces within the size of these instruments.

The mechanical principle at work is a transfer of energy and as such it is preferable for the moveable weight 10 to be made of a heavy material such as metal and to have an adequate weight to create the necessary shock such that not a lot of force is required to generate the shock.

The housing 16 may be made from any material that is sturdy such as aluminum or plastic. It may be preferable that the material is softer than the material the mouthpiece is constructed of, to prevent damage to the mouthpiece

Further, as may be seen in both FIG. 2 and FIG. 3, the mouthpiece extractor 32 is only in contact with the mouthpiece 30, and not with the lead pipe 34 or instrument 36. This reduces the chance that the mouthpiece extractor 32 causes damage to the lead pipe 34 while the mouthpiece 30 is being removed.

Referring now to FIG. 4, a flowchart illustrating how the present invention functions is depicted. A user inserts 46 the mouthpiece 30 into the mouthpiece remover 32. Next, the user slides 48 the moveable weight 10 from a first position close to the plug 6 to a second position close to the shaft shoulder 4. The moveable weight 10 strikes 50 the shaft shoulder/contact surface 4 creating a shock, which knocks the mouthpiece 30 from the lead pipe 34. The user now removes 52 the mouthpiece 30 from the mouthpiece remover 32.

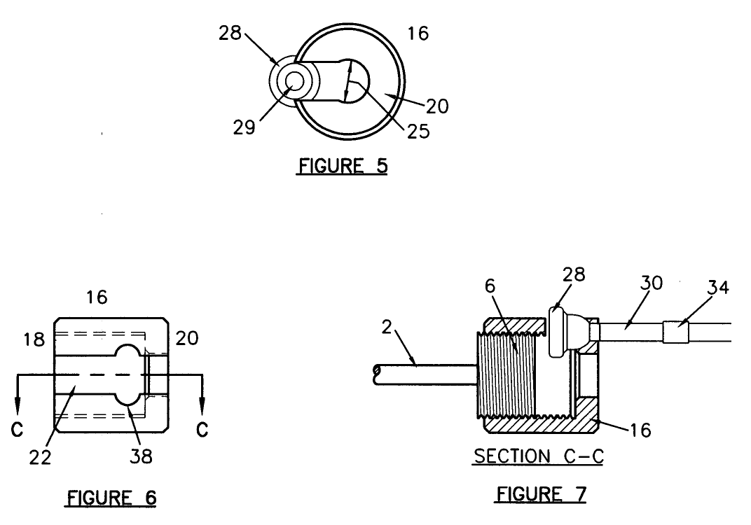

Referring now to FIG. 5, the instrument end 20 of the housing 16 is depicted. The narrower diameter opening 25 is sized to accommodate the shank 29 and lead pipe 34 but to prevent the rim 28 from passing therethrough.

Referring now to FIG. 6, an alternate embodiment of the housing 16 is depicted. In this embodiment, the housing 16 has an additional cutout 38, of sufficient size to allow the rim 28 to pass through the cutout 38.

Referring now to FIG. 7, the mouthpiece 30 may be inserted into the housing 16 even when the plug 6 is coupled with the housing 16. The mouthpiece 30 is dropped through the cutout 38, and the plug 6 is tightened in the housing, preventing the mouthpiece 30 from falling out. This embodiment is quicker to use, as the plug 6 and housing 16 do not need to be completely uncoupled to insert or remove the mouthpiece 30 from the housing 16.

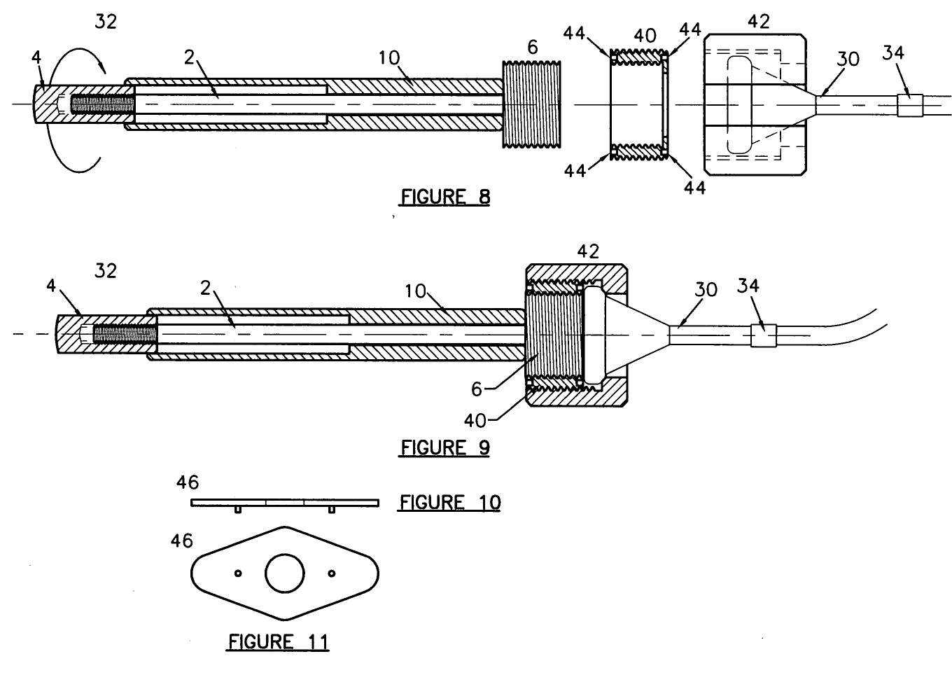

Referring now to FIG. 8 and FIG. 9, an alternate embodiment of the housing 16 for use with the device 32 is depicted. In this embodiment, a plug adapter sleeve 40 is coupled with the plug 6, and an alternate housing 42 is coupled with the plug adapter sleeve 40. The alternate housing 42 is similar to the housing 16, except that all dimensions are larger. This embodiment allows the removal of a mouthpiece 30 of a larger instrument 36 such as a Tuba or Bass Horn.

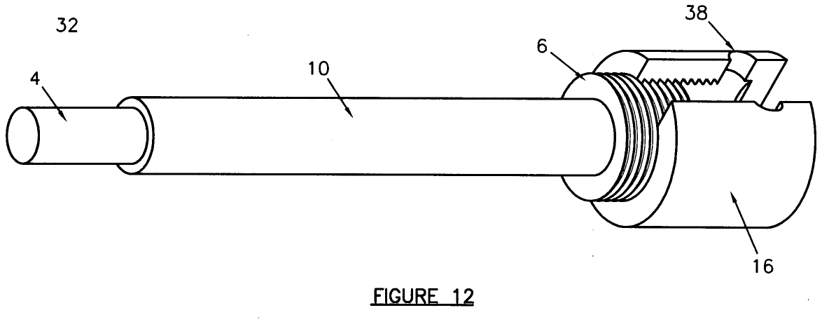

The plug adapter sleeve 40 has dowel holes 44. If the plug adapter sleeve 40 is attached to either the plug 6 or the alternate housing 42 and cannot be removed by hand, a key 46, depicted in FIG. 10 and FIG. 11 may be inserted into the dowel holes and turned until the plug adapter sleeve has been removed.

Referring now to FIG. 12, the mouthpiece remover 32 is ready for use. The plug 6 and housing 16 are coupled with one another. The rim 28 of mouthpiece 30 (not shown) may be inserted through the cutout 38, and the moveable weight 10 slid from the position depicted in FIG. 12 towards the shaft shoulder 4 to strike the shaft shoulder 4 and generate a shock to knock mouthpiece 30 from lead pipe 34.

It is therefore intended that the foregoing detailed description be regarded as illustrative rather than limiting, and that it be understood that it is the following claims, including all equivalents, that are intended to define the spirit and scope of this invention.

I claim:

1. A device for extracting a mouthpiece from a musical instrument where the mouthpiece has a shank and a rim and the musical instrument has a lead pipe, the shank fitting in the lead pipe, comprising:
a shaft, the shaft having a handle end and a plug end, the shaft further having a plug located at the plug end and a shaft shoulder located towards the handle end;
a housing operative to be coupled with the plug, the housing having means to allow insertion and removal of the mouthpiece, the housing and plug cooperating to hold the mouthpiece after it has been inserted;
a moveable weight, having a hollow center therethrough, the moveable weight operative to slide freely over the shaft; the plug preventing the moveable weight from sliding past the plug, and the shaft shoulder preventing the moveable weight from sliding past the shaft shoulder; and
whereby when the moveable weight is slid from the plug end to the handle end and the moveable weight strikes the shaft shoulder a shock is generated to knock the mouthpiece from the lead pipe.

2. The device of claim 1, wherein said plug is an externally threaded plug and said housing has a hollow threaded center therethrough, said plug and housing operative to be coupled in a threaded relationship.

3. The device of claim 2, wherein said housing further comprises a longitudinal slot running the length thereof, communicating with the hollow center and wider than the lead pipe; the hollow center further having:
a plug end diameter greater than the diameter of the rim of the mouthpiece;
an instrument end diameter less than the diameter of the rim of the mouthpiece but greater than the diameter of the lead pipe; and
whereby the shank of the mouthpiece is inserted into the housing through the longitudinal slot and the rim of the mouthpiece is prevented from passing beyond the instrument end diameter.

4. The device of claim 3, wherein said housing further comprises a cutout in the longitudinal slot, the cutout sized to accommodate the rim of the mouthpiece, whereby the mouthpiece may be inserted through the cutout into the device while the housing is coupled with the plug.

5. The device of claim 1, wherein said center of said moveable weight further defines an internal shoulder operative to contact said shaft shoulder to generate said shock.

6. The device of claim 2, wherein said housing comprises:
an internally and externally threaded plug adapter sleeve operative to be threaded onto said plug; and
a threaded adapter housing operative to be threaded onto the plug adapter sleeve, the adapter housing having means to allow insertion and removal of the mouthpiece, the adapter housing, adapter sleeve and plug cooperating to hold the mouthpiece after it has been inserted.

7. The device of claim 6, wherein said adapter housing further comprises a longitudinal slot running the length thereof, communicating with the hollow center and wider than the lead pipe; the hollow center further having:
a plug end diameter greater than the diameter of the rim of the mouthpiece;
an instrument end diameter less than the diameter of the rim of the mouthpiece but greater than the diameter of the lead pipe; and
whereby the shank of the mouthpiece is inserted into the housing through the longitudinal slot and the rim of the mouthpiece is prevented from passing beyond the instrument end diameter.

8. The device of claim 7, wherein said adapter housing further comprises a cutout in the longitudinal slot, the cutout sized to accommodate the rim of the mouthpiece, whereby the mouthpiece may be inserted through the longitudinal slot into the device while the adapter housing is coupled with the plug.

9. A method for removing a mouthpiece from a musical instrument using a mouthpiece extractor having a mouthpiece holder, a moveable weight and a contact surface, comprising:
inserting the mouthpiece remover to the mouthpiece such that the mouthpiece is held firmly by the mouthpiece holder;
sliding the moveable weight from a first position to a second position;
striking the contact surface in the second position such that a shock is generated to knock the mouthpiece from the lead pipe; and
removing the mouthpiece from the mouthpiece holder.
